(19) United States
(12) Patent Application Publication
(10) Pub. No.: US 2008/0080375 A1
(43) Pub. Date: Apr. 3, 2008

(54) Reception control method and receiving apparatus

(75) Inventor: Yoshihiro Haruta, Nakahara-ku (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/905,366

(22) Filed: Sep. 28, 2007

(30) Foreign Application Priority Data
Sep. 29, 2006 (JP) 267219/2006

(51) Int. Cl. H04L 12/26

(52) U.S. Cl. 370/230; 370/235

(57) ABSTRACT

A receiving control method and receiving apparatus to ensure high transfer efficiency and reliably reduce electrical power consumption in the receiving apparatus. A receive unit receives the header and the payload of the frames in the communication stream in sequence. A header analyzer unit analyzes whether or not the applicable frame is an unwanted frame from the frame accept-reject information included in the frame header during receiving. Calculating receive-end time unit in the receive control unit calculates the receive-end time t1 of the unwanted frame. Determining control unit stops the operation of the receive unit during the stop period based on the receive-end time t1 of the unwanted frame.

### BACKGROUND OF THE INVENTION

1. Field of the Invention

This invention relates to technology for receiving frames in communications.

2. Description of Related Art

Efforts to reduce electrical power consumption in devices are being made in various fields. For example, in the field of broadcasting, the technology disclosed in JP-A No. 2001-69106 discloses the technology for reducing electrical power consumption in a set box that receives broadcast waves transmitted by satellite broadcast, terrestrial broadcast, cable, and so on. Next the multiple elementary streams which included in the communication stream multiplexed onto the broadcast wave are multiply-separated, and further demodulates and outputs these streams as video or audio signals. This technology utilizes the fact that the actual data (also known as “payload”) in the transport packet need not be processed unless the identifier included in the header of the transport packet in the received communication stream matches a preset identifier (such as the identifier of a broadcast program that the viewer wants to watch). So this technology can reduce electrical power consumption in the set box by stopping the supply of synchronized clock pulses to the section that handles the processing for the header and actual data.

### SUMMARY

When there is no data needed to be processed by a task, stopping the operation of the task will lead to the reduction of the electrical power consumption. Next we consider a communication system for processing communication streams made up of some frames including some headers and some payloads. Receiving apparatus (also known as Receiver) in this type of communication systems usually analyze each frame headers and determine whether or not the frame is a frame that should be received. The receiving apparatus makes this determination based on whether the destination address in the header corresponds with its own address. If the receiving apparatus determines that the frame should be received, then the receiving apparatus receives the frame and processes it. On the other hand, if the receiving apparatus determines that the frame should not to be received, the receiving apparatus discards it as an unwanted frame.

In the receiving apparatus aforesaid, the section of the receiving circuit (physical layer, also known as “PHY”) also consumes electrical power. So, when the receiving apparatus determines that a frame is unwanted, suspending of receipt of the subsequent frames can reduce the electrical power consumption in the receiving circuit. By the way, the dilemma occurs as follows. Namely, in case that the timing of the restart procedure for receive the frames is too late after suspending of receipt, the transmit efficiency get worse. On the other hand, said timing is too early, the reduction effect of the electrical power consumption becomes less effective. This problem comes to the front particularly in handling the communication streams includes the frames whose length is variable.

One aspect of this invention is a receiving control method. During receiving of communication streams made up of frames including a header and a payload received after said header, this receiving control method analyzes frame accept-reject information showing whether or not the frame including the header is an unwanted frame among information in the frame headers during receive; and calculates the frame receive-end time. If analysis results then show that frame is an unwanted frame then the receiving circuit for that communication frame is made to stop operating within a stop period according to the receive end time for that unwanted frame.

Applying the above-mentioned method to a device, system, and a program is effective as another embodiment of this invention.

The technology of this invention is capable of ensuring transfer efficiency and reducing electrical power consumption on the receiving apparatus of the communication stream.

### BRIEF DESCRIPTION OF THE DRAWINGS

FIG. 1 is a block diagram showing the structure of the receiving apparatus of one embodiment of this invention;

FIG. 2 is a block diagram showing the structure of the receive control unit in the receiving apparatus shown in FIG. 1;

FIG. 3 is the first timing chart showing the operation of the receive control unit in FIG. 2;

FIG. 4 is the second timing chart showing the operation of the receive control unit in FIG. 2;

FIG. 5 is the third timing chart showing the operation of the receive control unit in FIG. 2;

FIG. 6 is a flow chart showing the processing flow in the receiving apparatus shown in FIG. 1.

### DETAILED DESCRIPTION OF THE PREFERRED EMBODIMENTS

The embodiments of this invention are described below with reference to the drawings.

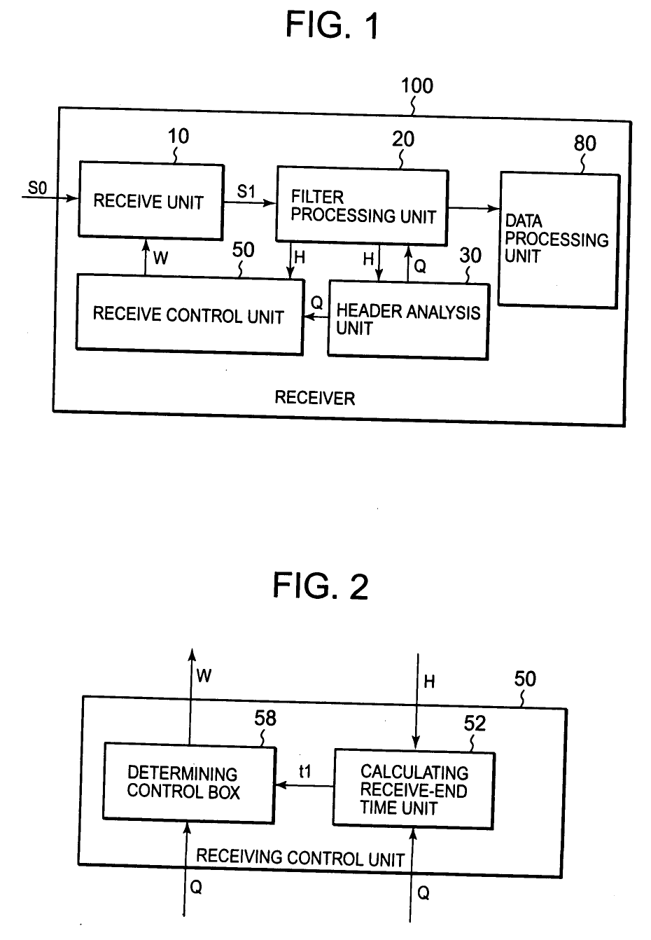

FIG. 1 is a block diagram showing the structure of a receiver 100 of the embodiment of this invention. The receiver 100 includes a receive unit 10 located on the physical layer, a filter processing unit 20, a header analysis unit 30, a receive control unit 50, and a data processing unit 80.

After receiving the signal S0 sent from the transmitter, the receive unit 10 performs processing such as synchronizing, and outputs a received signal S1 to the filter processing unit 20. The signal S0 is the communication stream contains multiple frames, and each of these frames includes a preamble, a header, and a payload which is the data body. The receive unit 10 utilizes the preamble of the frame which is included in the signal S0 to perform processing such as synchronizing, and each frame of the received signal S1 obtained in this way, includes a header and a payload. In the following description, the signal S0 is hereinafter called the received signal (AIR) S0 to be distinguished from the receiving signal S1.

The filter processing unit 20 discards the frame which should be destroyed or the unwanted frame on the one hand, and outputs the frame should not be destroyed to the data processing unit 80 on the other hand. To determine whether a frame is an unwanted frame or not, the header analysis unit 30 analyzes the frame accept-reject information included in the header H that was output from the filter processing unit 20.

The frame accept-reject information is information showing whether each of frames including the header H is an unwanted frame or not. In this embodiment, the destination address included in the header H is able to be assigned as the frame accept-reject information. The header analysis unit 30 compares the destination address included in the header H with the address of the receiver 100. And if the destination address corresponds with the address of the receiver 100, the header analysis unit 30 determines that the frame includes the header H is an unwanted frame. The header analysis unit 30 outputs the analysis results Q obtained in this way to both of the filter processing unit 20 and the receive control unit 50.

The receive control unit 50 controls the operation of the receive unit 10, which it should be operated or not. FIG. 2 is a block diagram showing the structure of the receive control unit 50.

The receive control unit 50 as shown in FIG. 2 includes a calculating receive-end time unit 52, and a determining control unit 58. When the analysis results Q from the header analysis unit 30 show that the currently received frame is an unwanted frame, the calculating receive-end time unit 52 calculates the receive-end time t of this frame, and supplies it to the determining control unit 58. Calculating the receive-end time t is executed with the use of at least one of the data transmission rate and the frame length described in the header H of the frame being received.

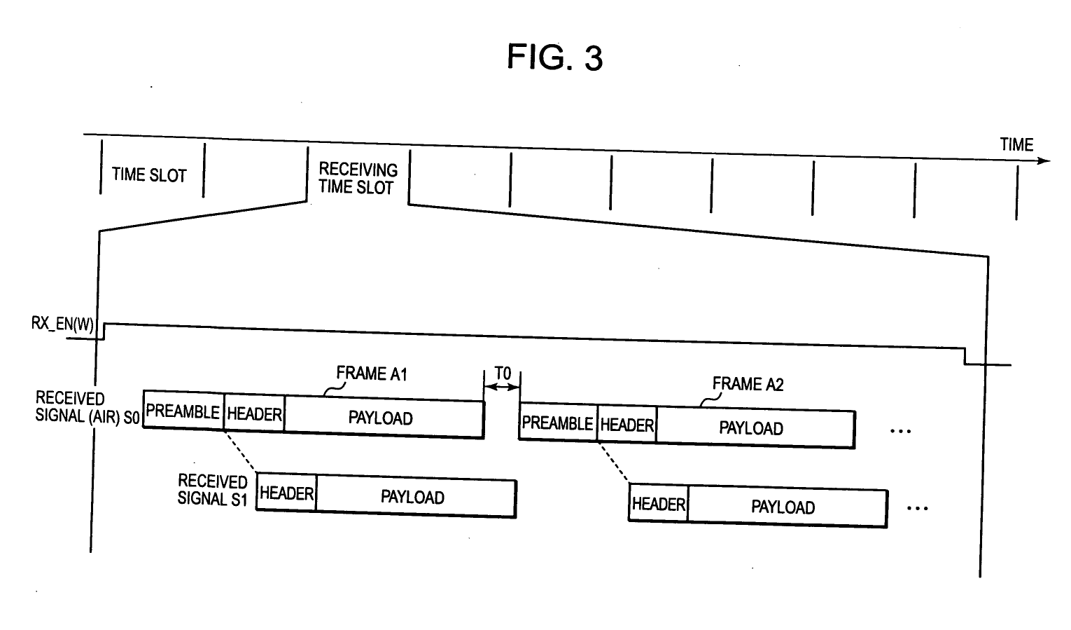

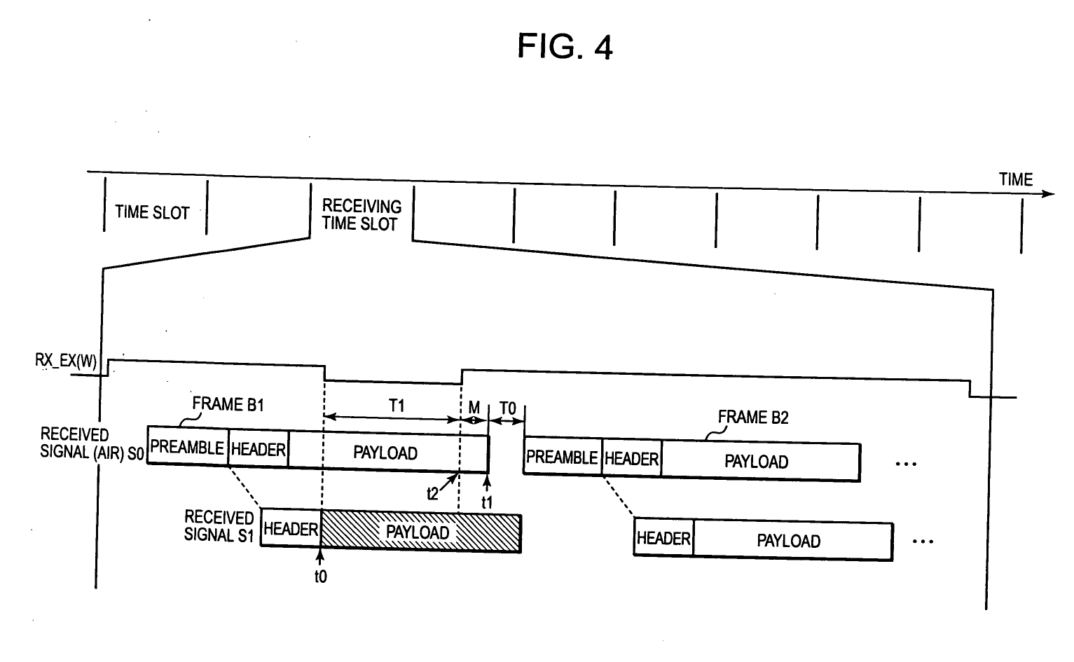

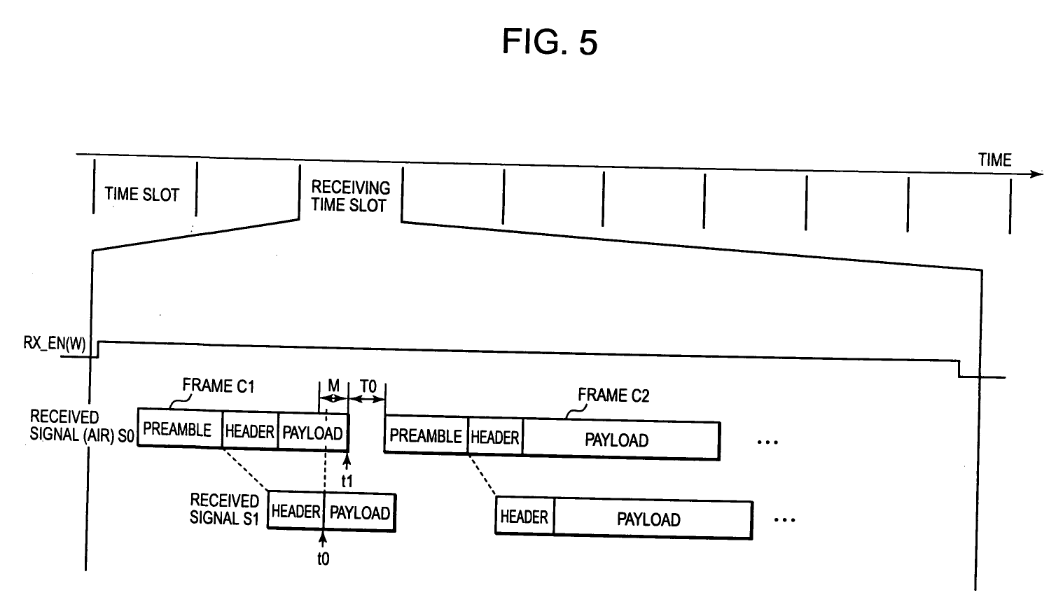

The determining control unit 58 operates the receive unit 10 in cases where the frame being received is not an unwanted frame. On the other hand, when the frame being received is an unwanted frame, the determining control unit 58 keeps the receive unit 10 on operating or stops the operation of the receive unit 10 according to the receive-end time t. The operation of the receive control unit 50 is hereinafter described in detail with reference to the timing charts in FIG. 3, FIG. 4, and FIG. 5.

The RX_EN in FIG. 3, FIG. 4, and FIG. 5 is the control command W that the determining control unit 58 outputs to the receive unit 10. The receive unit 10 operates when the RX_EN is at high (HI) level, and the receive unit 10 does not operate when the RX_EN is at low (LO) level. The received signal (AIR) S0 is a communication stream sent from the transmitter. This communication stream includes multiple frames which are received during the receiving time slot that is one of the time slots divided along the time axis. The received signal S1 is a signal the receive unit 10 outputs to the filter processing unit 20 after synchronous processing for received signal (AIR) S0. The black-colored section is shown in the figure for the sake of convenience to give a simplified explanation, this section is neither sent nor received by the receive unit 10 in fact. The T0 in the figure is the period between any two adjacent frames in received signal (AIR) S0. Usually, the transmitter will complete the transmission of the communication stream within a set receiving time slot. Because the frame period T0 fluctuates according to the frame length as above, a minimum value is defined the period T0 between any two adjacent frames in most communication standards.

FIG. 3 shows the case where there are not unwanted frames among any of the frames (frame A1, frame A2, . . . ) included in receive signal (AIR) S0. In this case, the analysis results Q output by the header analysis unit 30 to the filter processing unit 20 and the receive control unit 50 respectively show the frames that should be received. The filter processing unit 20 therefore outputs frames outputted from the receiver unit 10 to the data processing unit 80 without discarding the frames. Since there are no frames for disposal among these received frames, the calculating receive-end time unit 52 in the receive control unit 50 does not calculate the receive-end time t1. Moreover, the determining control unit 58 in the receive control unit 50 continues operating the receive unit 10 maintaining the RX_EN serving as analysis result Q, at a high (HI) level up to the receive-end of receive signal (AIR) S0.

FIG. 4 and FIG. 5 respectively show examples for the case where each of the frame B1 and C1 is an unwanted frame among some frames (frame B1, frame B2, . . . , frame C1, frame C2, . . . ) in received signal (AIR) S0. First, the case shown in FIG. 4 is explained.

In the example shown in FIG. 4, the destination address included in the header H of frame B1 does not match the address for the receiver 100, so the header analysis unit 30 determines that the frame B1 is an unwanted frame, and outputs analysis results Q indicates the determination to both of the filter processing unit 20 and the receive control unit 50.

After receiving these analysis results Q, the filter processing unit 20 discards the frame B1 and subsequent section and output nothing to the data processing unit 80. The time point where the filter processing unit 20 starts discarding the frames is hereafter called the filtering time.

The calculating receive-end time unit 52 in the receive control unit 50 calculates the receive-end time t1 of the frame B1 by utilizing the data transmission rate and the frame length for frame B1 included in the header H of frame B1 which is the unwanted frame, and outputs the receive-end time t1 to the determining control unit 58.

The determining control unit 58 determines whether or not to stop the receiving operation of the receive unit 10 based on the receive-end time t1. This determination is made according to whether the length of time interval from the start point of the stop period to the receive-end time t1 is longer or shorter than the margin M described later on.

According to the communication standards, to ensure that a frame can be received, the RX-EN for operating the receive unit 10 must be set to a high level before predetermined time of the arrival time for the beginning of said frame. This predetermined time can differ with respect to each standard. A margin M is set so that the restart of the receiving process is in time for reception of the beginning of the next frame in case the receiving process for a frame being received is suspended. As for the frame period TO a minimum value is defined in the communication standards as described above. In this embodiment, the margin M is a value determined by subtracting the minimum value for the frame period TO defined in the standards from the predetermined time described above, defined in the same standards.

The example shown in FIG. 4 indicates as follows. In frame B1 as the unwanted frame, the length between the start point t0 and the end point t1, that is the duration of stopping the operation of the receive unit 10, is larger than the margin M. So, the determining control unit 58 sets the RX_EN to a low level to stop the operation of receive unit 10. The end point t2 of this duration of stopping the operation is the time prior to the duration of margin M1 from the end point t1. The determining control unit 58 again sets the RX_EN to high level at the end point t2, and restarts operation of the receive unit 10. In this way the RX_EN becomes to high level before the duration D from the beginning of the next frame B2 arrives, so the frame B2 can be reliably received. (The duration D is sum of margin M and minimum value for the frame period defined in the standards).

The time point for determining whether or not the frame B1 is an unwanted frame, the filtering time (point), and the start point of the stop period during the receiving operation of the receive unit 10 is stopped are explained next.

In this embodiment, determining whether or not a frame is unwanted is made by whether or not the address of the receiver 100 corresponds with the destination address included in the header H of the frame. In other words, if the destination address included in the header H is supplied to the header analysis unit 30, then a determining can be made even if not all of the header H data has been completely received.

The filter processing unit 20 discards the frame if the frame being received is determined by the header analysis unit 30 is an unwanted frame. So the filter time is the time that the filter processing unit 20 starts to discard the unwanted frame. This start time is likely to vary depending on the actual circuit design. For example it can be set one clock pulse later than the analysis result Q output by the header analysis unit 30.

The start point of the stop period for stopping the operation of the receive unit 10 is also likely to vary depending on the specific design of the circuit. A stop period should be as long as possible from the viewpoint of reducing electrical power consumption, it is preferably a time as soon as possible after obtaining the receive-end time t1 from the calculating receive-end time unit 52.

The time point of determining whether the frame B1 is an unwanted frame or not, the filtering time, and the start point for the stop period for stopping the receiving operation of the receiver unit 10 are as described above. However, for clarifying the following description and drawings, above three time points set as the time point t0 where all data for the header H is supplied to the header analysis unit 30.

As shown in FIG. 4, the receiving operation of the receive unit 10 is stopped in the period T1 from the start point of stop period t0 to the end point t2 for frame B1, and its payload is not received (black-colored portion in FIG. 4).

In the example in FIG. 5, the destination address included in the header H of frame C1 does not disagree with the address of the receiver 100. So the header analysis unit 30 determines that frame C1 is an unwanted frame, and the analysis result Q indicates the determination is output to both of the filter processing unit 20 and the receive control unit 50.

The filter processing unit 20 discards sections subsequent to the frame C1 when receiving the analysis result Q, and outputs nothing to the data processing unit 80.

The calculating receive-end time unit 52 of receive control unit 50 calculates the receive-end time t1 for the frame C1 which is the unneeded frame and outputs it to the determining control unit 58.

By the way, as for frame C1 as shown in the figure, the length between the start point of the stop period for the receive unit 10 and receive-end time t1 is shorter than or equal to the margin M. The determining control unit 58 therefore does not stop the receiving operation of the receive unit 10, and maintains the RX_EN at the high level. When the length of the receive-end time t1 and the start point of the stop period for the receive unit 10 is shorter than or equal to the margin M, and the operation of receive unit 10 is stopped, the restart timing might then not allow reliably receiving the start of the next frame (frame C2). Therefore, when the length of the receive-end time t1 and start point for the receive unit 10 stop period is shorter than or equal to the margin M, the determining control unit 58 maintains RX_EN unchanged at high level without stopping the receive operation of receive unit 10, even if the frame is an unwanted frame. In this way the next frame can be reliably received, and the transfer efficiency of the communication stream is maintained.

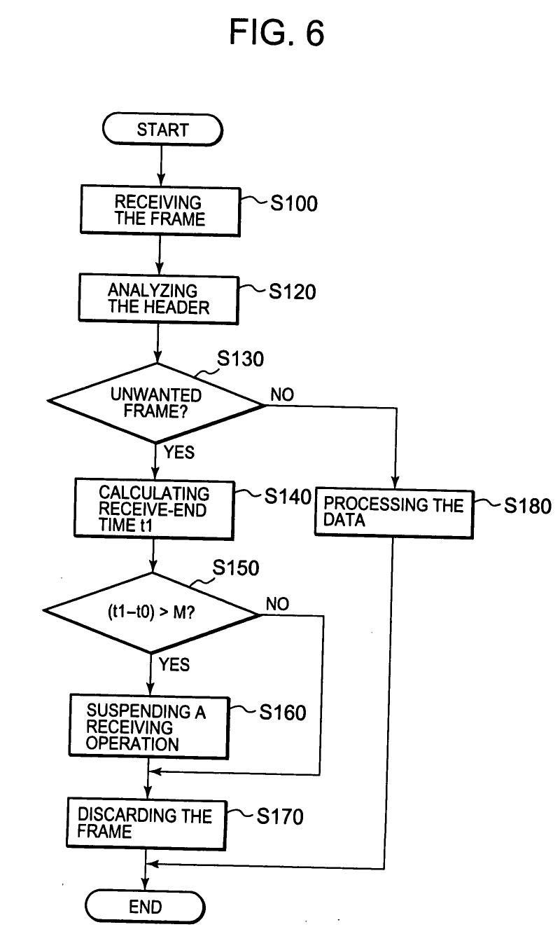

FIG. 6 is a flow chart showing the processing flow for each frame in the receiver 100 shown in FIG. 1. After starting to receive the frame, the receive unit 10 performs receiving process and outputs it from the frame header to the filter processing unit 20 (S100). The header analysis unit 30 analyzes the frame accept-reject information included in the header H supplied from the filter processing unit 20, obtains the analysis result Q showing whether that frame is an unwanted frame or not, and outputs it to both of the filter processing unit 20 and the receive control unit 50 (S120). When the frame is not an unwanted frame (S130: No) the filter processing unit 20 does not discard the frame but outputs the frame to the data processing unit 80, and processing is performed by the data processing unit 80 (S180).

On the other hand, when the frame is an unwanted frame (S130: Yes) then the calculating receive-end time unit 52 in the receive control unit 50 calculates the receive-end time t1 for said frame, and outputs it to the determining control 58 (S140). If the length between the receive-end time t1 and start point t0 for the stop period, during the stop of the operation of the receive unit 10, is larger than or equal to the margin M (S150: Yes), then the receive unit 10 operation is stopped within the stop period t1 from the start point t0 to the end point t2 (receive-end time t1-margin M), and the receiving process is stopped (S160). On the other hand, when the length between the receive-end time period t1 and start point t0 for the stop period is smaller than or equal to the margin M (S150: No), then the receiving operation of receive unit 10 is continued, even if the frame is an unwanted frame. When the header analysis unit 30 determines that the frame being received is an unwanted frame (S130: Yes) then the filter processing unit 20 discards that frame and outputs nothing to the data processing unit 80 (S170).

This processing is performed for all frames included in the communication stream.

When the receiver 100 of this embodiment of the invention stop the receiving operation of the receive unit 10, the receiver 100 calculates the receive-end time t1 of this frame and decides an end point of the stop period in time for receiving the beginning of the next frame based on the calculated result.

In this way the transfer efficiency of the communication stream can be maintained while suppressing electrical power consumption to the utmost, even in communication streams where the frame lengths are variable.

And, in this invention, the receiving operation of the receive unit 10 is not stopped, when the length from the start point of the stop period until the receive-end time t1 is less than or equal to the margin M1, even when the frame is an unwanted frame. The next frame can in this way be reliably and safely received even for unwanted frames whose length is small.

Although the invention has been described above in connection with several preferred embodiments thereof, it will be appreciated by those skilled in the art that those embodiments are provided solely for illustrating the invention, and should not be relied upon to construe the appended claims in a limiting sense.

For example, in the receiver 100 of this embodiment, the calculating receive-end time unit 52 calculates the receive-end time t1 for only unwanted frames. The calculating receive-end time unit 52 therefore does not operate for frames other than unwanted frames herewith, so electrical power consumption in the calculating receive-end time unit 52 can be reduced. Moreover, the calculating receive-end time unit 52 may also be used for example to calculate the receive-end time t1 for all frames. In this case, because the calculation of the receive-end time t1 and the determining whether the frame is an unwanted frame or not by the header analysis unit 30 are performed in parallel, the determining control unit 58 can determine sooner whether or not to stop the receive unit 10 operation after receiving the analysis result Q that the frame is unwanted from the header analysis unit 30. Consequently the receive operation of the receive unit 10 can be stopped even faster.

In the embodiment described above, the determining whether a frame is an unwanted frame or not is performed based on whether the destination address included in the frame header corresponds with the receiver 100's own address. However, this invention may also be applied to receiving communication streams made up of frames where frame accept-reject information showing whether a frame is unwanted or not is included in the header. This frame accept-reject information is not limited to the destination address, and may apply to any form such as a flag directly showing whether if the frame is unwanted or not.

What is claimed is:

1. A receiving apparatus comprising:
an input terminal to which a communication streams including a header and a payload;
a receive unit coupled to said terminal; and
a receive control unit coupled to said receive unit and responsive to frame accept-reject information in the header to suspend a receiving operation of the receive unit.

2. The receiving apparatus according to claim 1, wherein the receive control unit calculates a receive-end time using at least one of the frame length included in the header and the data transmission rate.

3. The receiving apparatus according to claim 1, wherein the receive control unit calculates the receive-end time of the frame being received, and determines a suspend time of the receive operation of the receiving unit based on the receive-end time.

4. The receiving apparatus according to claim 3, wherein the receive control unit calculates the receive-end time when the frame accept-reject information indicates an unwanted frame.

5. The receiving apparatus according to claim 1, wherein the receive control unit starts to suspend the receiving operation when the frame accept-reject information indicates an unwanted and terminates to suspend the receiving operation of the receive unit in response to a receive-end time based on a frame length included in the header and a data transmission rate.

6. The receiving apparatus according to claim 5, wherein the receive unit does not suspend the receiving operation of the receive unit when the length of the period from the suspend start to the end of the payload is less than or equal to the specified time.

7. The receiving apparatus according to claim 1, further comprising:
a processing unit coupled to said receiving unit to be supplied with data including at least said payload; wherein said receive control unit does not suspend processing unit

8. A receiving control method comprising:
receiving a communication streams including a header and a payload at a receive unit; and
suspending a receiving operation of the receive unit based on frame accept-reject information in the header.

9. The receiving control method according to claim 8, further comprising:
calculating a receive-end time using at least one of the frame length included in the header and the data transmission rate.

10. The receiving control method according to claim 8, wherein
the calculating the receive-end time of the frame being received, and further comprising:
determining a suspend time of the receiving operation of the receiving unit based on the receive-end time.

11. The receiving control method according to claim 10, wherein
the calculating the receive-end time when the frame accept-reject information indicates an unwanted frame.

12. The receiving control method according to claim 8, further comprising:
starting of the suspend of the receiving operation when the frame accept-reject information indicates an unwanted; and
terminating of the suspend of the receiving operation of the receive unit in response to a receive-end time based on a frame length included in the header and a data transmission rate.

13. The receiving control method according to claim 12, wherein
the suspending the receiving operation of the receiving unit does not suspend when the length of the period from the suspend start to the suspend termination is less than or equal to the specified time.
